(19) United States
(12) Patent Application Publication
(10) Pub. No.: US 2014/0215269 A1
(43) Pub. Date: Jul. 31, 2014

(54) TEST INFRASTRUCTURE SIMULATION

(71) Applicant: HEWLETT-PACKARD DEVELOPMENT COMPANY, L.P., Houston, TX (US)

(72) Inventor: Oh Sung, Roseville, CA (US)

(73) Assignee: Hewlett-Packard Development Company, L.P., Houston, TX (US)

(21) Appl. No.: 13/751,406

(22) Filed: Jan. 28, 2013

(51) Int. Cl. G06F 11/273; G06F 11/26

(52) U.S. Cl. CPC G06F 11/273; G06F 11/261
USPC 714/28; 714/30

(57) ABSTRACT

Systems, methods, and machine-readable and executable instructions are provided for operating a test infrastructure simulation. Operating a test infrastructure simulation can include executing a test on a number of units under test (UUT) coupled to a test infrastructure and determining capabilities of the test infrastructure based on results of the test executed on the number of UUTs coupled to the test infrastructure.

### BACKGROUND

Assembling a system architecture can include a manual assembly of physical hardware (e.g., servers, cable connections, displays, etc.). Validation, e.g., testing, of the system architecture can include using test infrastructure to validate that the physical hardware is connected properly, that the software and/or firmware is updated, and/or that software is operational. Validation of the system architecture can include using test infrastructure to execute a test on a number of units under test (UUT).

### BRIEF DESCRIPTION OF THE DRAWINGS

FIG. 1 illustrates a diagram of an example of an automated test infrastructure simulation environment and test infrastructure according to the present disclosure.

FIG. 2 illustrates a diagram of an example of an automated test infrastructure simulation environment and test executives according to the present disclosure.

FIG. 3 illustrates a flow chart of an example of a method for test infrastructure simulation according to the present disclosure.

FIG. 4 illustrates a block diagram of an example of a system according to the present disclosure.

### DETAILED DESCRIPTION

A test infrastructure simulation can include executing a test on a number of units under test (UUT) coupled to a test infrastructure and determining capabilities of the test infrastructure based on results of the test executed on the number of UUTs coupled to the test infrastructure. Test infrastructure can be used to implement a test on a system architecture. While a test is performed on a system architecture, the system architecture can be referred to as a unit under test (UUT).

A test infrastructure simulation can include using a test infrastructure and an automated test infrastructure simulation environment (ATISE) to determine the capabilities of the test infrastructure. The test infrastructure used in the test infrastructure simulation can be a test infrastructure that models the test infrastructure of a factory and/or can be a test infrastructure that includes changes and/or upgrades to a test infrastructure that will be incorporated at a factory. The test infrastructure can include servers, processors, and/or media, among other components used to perform a test on UUTs.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure. As used herein, “a” or “a number of” something can refer to one or more such things. For example, “a number of articles” can refer to one or more articles.

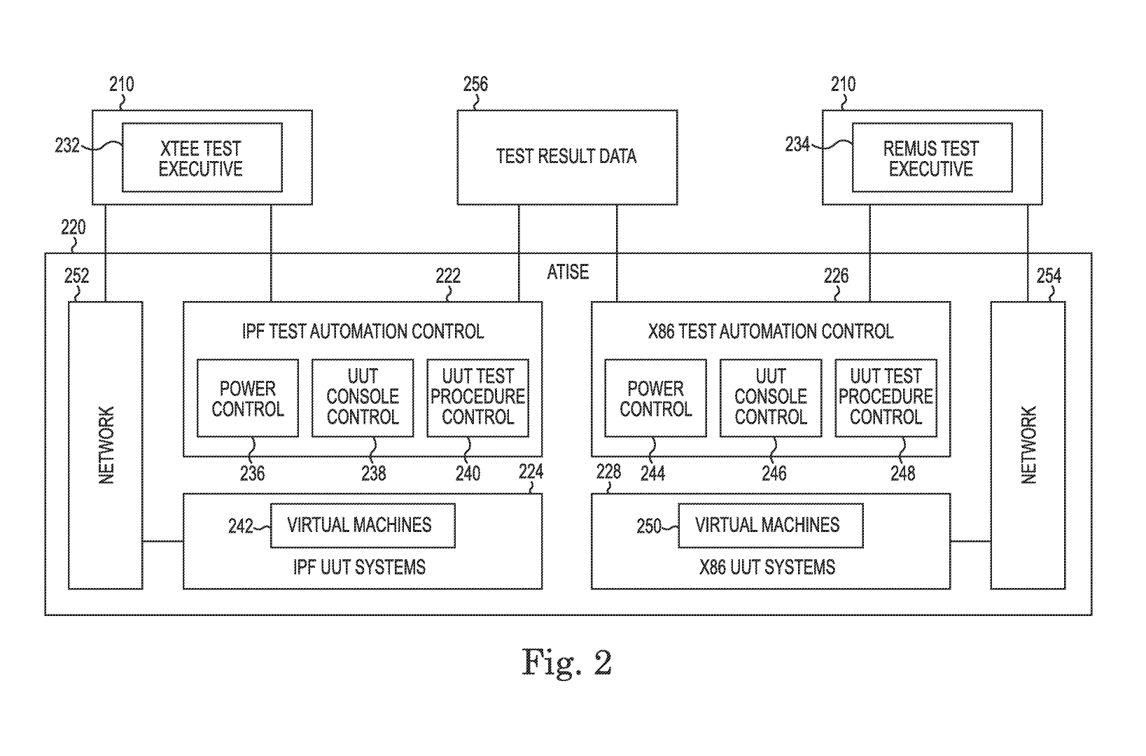

The figures herein follow a numbering convention in which the first digit corresponds to the drawing figure number and the remaining digits identify an element or component in the drawing. For example, reference numeral 204 in FIG. 2 can identify element “04”, while an analogous element may be identified as 604 in FIG. 6. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

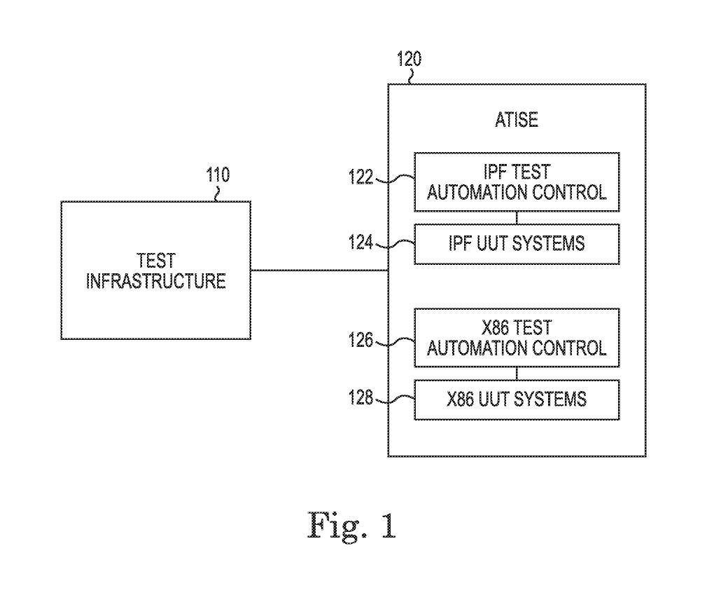

FIG. 1 illustrates a diagram of an example of an automated test infrastructure simulation environment (ATISE) 120 and test infrastructure 110 according to the present disclosure. ATISE 120 can include an itanium processor family (IPF) test automation controller 122 and a number of IPF UUT systems 124. ATISE 120 can include an ×86 test automation controller 126 and a number of ×86 UUT systems 128. ATISE 120 can provide an environment for testing UUTs with both IPF based systems and ×86 base systems. The test infrastructure 110 can execute tests on the UUTs in ATISE 120 to determine the capabilities of the test infrastructure 100. The capabilities of the test infrastructure 110 that can be determined can include the speed with which the tests on the UUTs can be performed, the number of UUTs that can be tested by the test infrastructure 100, and/or whether the tests are properly executed on the UUTs by the test infrastructure 110, among other capabilities.

The test infrastructure 110 is configurable to simulate a factory's test infrastructure. For example, test infrastructure can be configured with the hardware, software, and firmware configurations of a factory's test infrastructure. The software and firmware configuration can include computer-readable instructions used to execute tests on UUTs. ATISE 120 can have a static configuration, e.g., a constant number of UUTs having the same configuration among the number of UUTs, while various test infrastructure configurations can be used when executing tests on the number of UUTs. The tests executed by the test infrastructure on the number of UUTs can be used to determine the capabilities of the test infrastructure and the effect that the various test infrastructure configurations have on the capabilities of the test infrastructure. For example, the test infrastructure can have various configurations having a number of servers, a number of network bandwidths, a number of power control settings, a number of operating systems, a number of media configurations, a number of kernel configurations, a number of software configurations, and/or a number of tests to execute, among other configurable options.

The test infrastructure can be configured to determine the effect that various hardware, software, and/or firmware changes to the test infrastructure have on the capabilities of the test infrastructure. The test infrastructure and the ATISE can be used to determine the effects of configuration changes to the test infrastructure, so that similar test infrastructures in factories do not have to shut down to determine the effects of changing the test infrastructure in the factory.

FIG. 2 illustrates a diagram of an example of an automated test infrastructure simulation environment and test infrastructure having test executives according to the present disclosure. In FIG. 2, the test infrastructure 210 includes an extensible test executive environment (XTEE) test executive 232 and a remote environment monitoring unit system (REMUS) test executive 234. A test executive is part of the test infrastructure 210 that can configure tests and execute tests on UUTs. The XTEE test executive 232 can execute tests on IPF UUT systems and the REMUS test executive 234 can execute tests on ×86 UUT systems.

The XTEE test executive 232 can be coupled to the IPF test automation control 222 via an RS232 port. The IPF test automation control 222 includes a power control 236 for controlling power to the IPF UUT systems 224. The IPF test automation control 222 also includes a UUT console control 238 and a UUT test procedure control 240. The UUT console control 238 includes an interface to communicate between the XTEE test executive 232 and the IPF test automation control 222. The UUT console control 238 can allow for communication to determine the test that will be executed, when the test will be executed, and what information the test will provide, among other functions. The UUT test procedure control 240 can control execution of the test on the IPF UUT systems 224. The UUT test procedure control 240 can receive instructions for a test from the XTEE test executive 232 and facilitate execution of the test on the IPF UUT systems 224. The results of the tests executed on the IPF UUT systems can be communicated from the IPF test automation control 222 to the test result data 256. The test result data 256 can be stored in the test infrastructure 210 and/or in another location, such as a database, for analysis. The test result data 256 can be analyzed to determine the capabilities of the test infrastructure 210. The IPF UUT systems 224 can include systems that simulate systems assembled at factories. Portions of the IPF UUT systems on which tests are performed can include virtual machines 224, which can use cloud computing resources from network 252.

The REMUS test executive 234 can be coupled to the ×86 test automation control 226 via an RS232 port and/or an iLo. The ×86 test automation control 226 in includes a power control 244 for controlling power to the ×86 UUT systems 228. The ×86 test automation control 226 also includes a UUT console control 246 and a UUT test procedure control 248. The UUT console control 246 includes an interface to communicate between the REMUS test executive 234 and the ×86 test automation control 226. The UUT console control 246 can allow for communication to determine what test will be execute, when the test will be executed, and what information the test will provide, among other functions. The UUT test procedure control 248 can control execution of the test on the ×86 UUT systems 228. The UUT test procedure control 248 can receive instructions for a test from the REMUS test executive 234 and facilitate execution of the test on the ×86 UUT systems 228. The results of the tests executed on the ×86 UUT systems 228 can be communicated from the ×86 test automation control 226 to the test result data 256. The test result data 256 can be stored in the test infrastructure 210 and/or in another location, such as a database, for analysis. The test result data 256 can be analyzed to determine the capabilities of the test infrastructure 210. The ×86 UUT systems 228 can include systems that simulate systems assembled at factories. Portions of the ×86 UUT systems 228 on which tests are performed can include virtual machines 250, which can use cloud computing resources from network 254.

The capabilities of the test infrastructure that can be determined via the test result data 256 include a UUT capacity for the test infrastructure, a hardware configuration for the test infrastructure, a software configuration for the test infrastructure, a schedule for implementing the test infrastructure in a factory and/or a resource plan for implementing the test infrastructure in a factory. The test result data can be used to determine the schedule for implementing the test infrastructure, such as when changes to a test infrastructure will be implemented at a factory, for example. The test result data can also be used to determine a resource plan for implementing the test infrastructure in a factory, such as the resources that will be used when changes to a test infrastructure are implemented at a factory, for example.

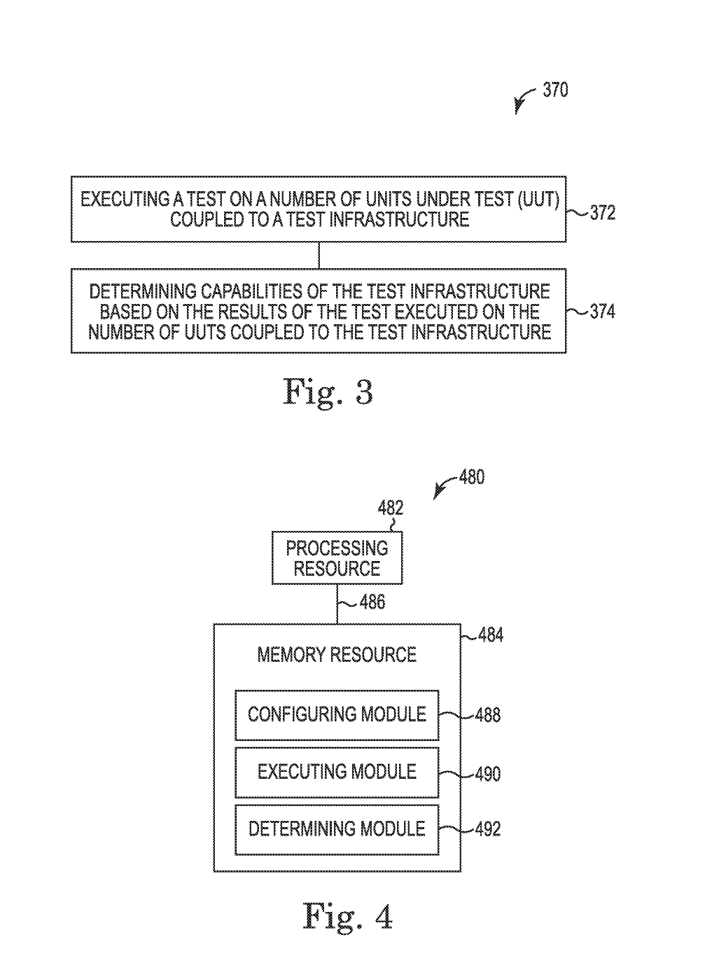

FIG. 3 illustrates a flow chart of an example of a method 370 for test infrastructure simulation according to the present disclosure. The method 370 can determine capabilities of a test infrastructure that simulates a test infrastructure in a factory and/or simulates changes that could be made to a test infrastructure in a factory, so that the capabilities of the test infrastructure at the factory can be known without having to shut down production at the factory to test the factory's test infrastructure or actually make changes to the factory's test infrastructure without knowledge of the effects that the changes will have on the factory's test infrastructure's capabilities.

At box 372 the method 370 can include executing a test on a number of units under test (UUT) coupled to a test infrastructure. Executing a test on a number of UUTs can include using a test executive on the test infrastructure to execute a test on a number of UUTs. The UUTs can be on an automated test infrastructure simulation environment (ATISE) and the ATISE can include a test automation control and UUT systems for execution of the test by the test infrastructure. The test infrastructure can be configured with various hardware, software, and/or firmware configurations and the text executive can be configured to execute a number of tests on a number of UUTs.

At box 374 the method 374 can include determining capabilities of the test infrastructure based on the results of the test executed on the number of UUTs coupled to the test infrastructure. The capabilities of the test infrastructure that are determined can include the number of UUTs that can be tested by the test infrastructure, the type of test that can be executed by the test infrastructure, and/or the rate at which a test can be executed by the test infrastructure, among other capabilities. These determined capabilities of a test infrastructure can be used when determining the configuration of a test infrastructure at a factory, depending on the desired capabilities of the test infrastructure at the factory.

FIG. 4 illustrates a block diagram of an example of a system 480 according to the present disclosure. The system 480 can utilize software, hardware, firmware, and/or logic to perform a number of functions.

The system 480 can be any combination of hardware and program instructions configured to share information. The hardware, for example can include a processing resource 482 and/or a memory resource 484 (e.g., computer-readable medium (CRM), machine readable medium (MRM), database, etc.) A processing resource 482, as used herein, can include any number of processors capable of executing instructions stored by a memory resource 484. Processing resource 482 may be integrated in a single device or distributed across multiple devices. The program instructions (e.g., computer-readable instructions (CRI)) can include instructions stored on the memory resource 484 and executable by the processing resource 482 to implement a desired function (e.g., determining capabilities of a test infrastructure, etc.).

The memory resource 484 can be in communication with a processing resource 482. A memory resource 484, as used herein, can include any number of memory components capable of storing instructions that can be executed by processing resource 482. Such memory resource 484 can be a non-transitory CRM. Memory resource 484 may be integrated in a single device or distributed across multiple devices. Further, memory resource 484 may be fully or partially integrated in the same device as processing resource 482 or it may be separate but accessible to that device and processing resource 482. Thus, it is noted that the system 480 may be implemented on a user and/or a participant device, on a server device and/or a collection of server devices, and/or on a combination of the user device and the server device and/or devices.

The processing resource 482 can be in communication with a memory resource 484 storing a set of CRI executable by the processing resource 482, as described herein. The CRI can also be stored in remote memory managed by a server and represent an installation package that can be downloaded, installed, and executed. The system 480 can include memory resource 484, and the processing resource 482 can be connected to the memory resource 484.

Processing resource 482 can execute CRI that can be stored on an internal or external memory resource 484. The processing resource 482 can execute CRI to perform various functions, including the functions described with respect to FIGS. 1, 2, and 3. For example, the processing resource 482 can execute CRI to execute a test on a number of UUTs coupled to a test infrastructure.

A number of modules 488, 490, and 492, can include CRI that when executed by the processing resource 482 can perform a number of functions. The number of modules 488, 490, and 492 can be sub-modules of other modules. For example, the configuring module 488 and the executing module 490 can be sub-modules and/or contained within the same computing device. In another example, the number of modules 488, 490, and 492 can comprise individual modules at separate and distinct locations (e.g., CRM, etc.).

A configuring module 488 can include CRI that when executed by the processing resource 482 can configure a number of hardware, software, and/or firmware features of a test infrastructure. The configuration module 488 can configure various combinations of a number of servers, a number of network bandwidths, a number of power control settings, a number of operating systems, a number of media configurations, a number of kernel configurations, a number of software configurations, and/or a number of tests to execute, among other configurable options, for the test infrastructure.

An executing module 490 can include CRI that when executed by the processing resources 482 can execute a test by a test infrastructure on a number of UUTs on an automated test infrastructure simulation environment (ATISE). The executing module 490 can execute a test on a number UUTs using a test executive. The text executive can be configured to execute a test on IFP UUTs, using an XTEE test executive, and can also be configured to execute a test on ×86 UUTs, using a REMUS test executive.

A determining module 492 can include CRI that when executed by the processing resource 482 can determine capabilities of the test infrastructure based on the results of the test executed on the number of UUTs on the ATISE. The determining module 492 can determine capabilities of the test infrastructure based on the test results data. The test results data can be used to determine a UUT capacity for the test infrastructure, a hardware configuration for the test infrastructure, a software configuration for the test infrastructure, a schedule for implementing the test infrastructure in a factory and/or a resource plan for implementing the test infrastructure in a factory.

A memory resource 484, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 484 can be integral, or communicatively connected, to a computing device, in a wired and/or a wireless manner. For example, the memory resource 484 can be an internal memory, a portable memory, a portable disk, or a memory associated with another computing resource (e.g., enabling CRIs to be transferred and/or executed across a network such as the Internet).

The memory resource 484 can be in communication with the processing resource 482 via a communication link (e.g., path) 486. The communication link 486 can be local or remote to a machine (e.g., a computing device) associated with the processing resource 482. Examples of a local communication link 486 can include an electronic bus internal to a machine (e.g., a computing device) where the memory resource 484 is one of volatile, non-volatile, fixed, and/or removable storage medium in communication with the processing resource 482 via the electronic bus.

The communication link 486 can be such that the memory resource 484 is remote from the processing resource (e.g., 482), such as in a network connection between the memory resource 484 and the processing resource (e.g., 482). That is, the communication link 486 can be a network connection. Examples of such a network connection can include a local area network (LAN), wide area network (WAN), personal area network (PAN), and the Internet, among others. In such examples, the memory resource 484 can be associated with a first computing device and the processing resource 482 can be associated with a second computing device (e.g., a Javeserver). For example, a processing resource 482 can be in communication with a memory resource 484, wherein the memory resource 484 includes a set of instructions and wherein the processing resource 482 is designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method of operating a test infrastructure simulation, comprising:
executing a test on a number of units under test (UUT) coupled to a test infrastructure; and
determining capabilities of the test infrastructure based on results of the test executed on the number of UUTs coupled to the test infrastructure.

2. The method of claim 1, wherein executing the test includes executing the test via a test executive.

3. The method of claim 2, wherein executing the test via the test executive includes using an extensible test executive environment (XTEE).

4. The method of claim 2, wherein executing the test via the test executive includes using a remote environment monitoring unit system (REMUS).

5. The method of claim 1, wherein determining capabilities of the test infrastructure includes determining a UUT capacity for the test infrastructure.

6. The method of claim 1, wherein determining capabilities of the test infrastructure includes determining a hardware configuration for the test infrastructure.

7. The method of claim 1, wherein determining capabilities of the test infrastructure includes determining a software configuration for the test infrastructure.

8. The method of claim 1, wherein determining capabilities of the test infrastructure includes determining a schedule for implementing the test infrastructure in a factory.

9. The method of claim 1, wherein determining capabilities of the test infrastructure includes determining a resource plan for implementing the test infrastructure in a factory.

10. The method of claim 1, including configuring the test infrastructure to simulate a test infrastructure of a factory.

11. A non-transitory computer-readable medium storing a set of instructions for operating a test infrastructure simulation environment executable by a processing resource to:
configure a test infrastructure for testing a number of units under test (UUT) coupled to the test infrastructure;
execute a test on the number of UUTs coupled to the test infrastructure via test executive; and
determine capabilities of the test infrastructure based on the results of the test on the number UUTs.

12. The medium of claim 11, wherein the instructions are executable to:
configure the test infrastructure for testing of a number of Itanium based UUTs coupled to the test infrastructure.

13. The medium of claim 11, wherein the instructions are executable to:
configure the test infrastructure for testing of a number of ×86 based UUTs coupled to the test infrastructure.

14. A test infrastructure simulation environment, comprising:
a test infrastructure configured to simulate a factory, wherein the test infrastructure includes a test executive; and
an automated test infrastructure simulation environment (ATISE), wherein the ATISE includes a test automation control and a number of units under test (UUT) systems coupled to the test infrastructure, and wherein a number of test are executed by the test executive on the number of UUT systems to determine the capabilities of the test infrastructure.

15. The test infrastructure simulation environment of claim 14, wherein the tests are executed by the test executive on the number of UUT systems to determine a UUT capacity for the test infrastructure.
